(19) United States
(12) Patent Application Publication
(10) Pub. No.: US 2012/0182564 A1
(43) Pub. Date: Jul. 19, 2012

(54) PRINTING METHOD AND PRINTING APPARATUS

(75) Inventor: Hideo Shibaoka, Kawasaki-shi (JP)

(73) Assignee: CANON KABUSHIKI KAISHA, Tokyo (JP)

(21) Appl. No.: 13/348,473

(22) Filed: Jan. 11, 2012

(30) Foreign Application Priority Data
Jan. 18, 2011 (JP) 2011-007987

(51) Int. Cl. H04N 1/60; G06K 15/02

(52) U.S. Cl. 358/1.9; 358/1.18

(57) ABSTRACT

A method for printing information of items relating to a print setting on a sheet includes acquiring information relating to a width of the sheet to be used, setting a layout for printing the information of the items according to the acquired width, and printing the information of the items on the sheet according the set layout.

### BACKGROUND OF THE INVENTION

1. Field of the Invention

The present invention relates to a technique of status print used to check setting items relating to printing by an operator.

2. Description of the Related Art

In a printing apparatus, a function called “status print” for printing out information of various items relating to a print setting on a sheet in characters is known. An operator checks the output information and repeatedly performs test prints by changing the items as necessary so that print quality can be adjusted to a desired level. A technique relating to the status print is discussed in Japanese Patent Application Laid-Open No. 2000-263895.

In such a status print, an output layout of information to be printed on a sheet is determined beforehand. As illustrated in FIGS. 6A and 6B, the information is arranged and output in a row direction and a column direction with an upper left side of a leading edge of a sheet as a reference.

This output layout remains the same regardless of a size (width) of a sheet to be used. Consequently, a blank area on a right side of a sheet (a waste area) that is not used to output the information, increases in size as a size of the sheet to be used increases, as illustrated in FIGS. 6A and 6B. This problem is notable when a continuous sheet such as a roll sheet is used. Further, in the conventional status print, all of the information is always output in the similar style. Such an output style creates difficulty for an operator to promptly recognize which setting has been changed when the status print is performed after a portion of printing apparatus settings is changed.

### SUMMARY OF THE INVENTION

The present invention provides a method for reducing a sheet consumption amount needed for the status print. In addition, the present invention provides a method for allowing an operator who sees an output of the status print to promptly recognize a changed item when a printing apparatus setting is changed.

According to an aspect of the present invention, a method for printing information of items relating to a print setting on a sheet, includes acquiring information relating to a width of a sheet to be used, setting a layout for printing the information of the items according to the acquired width;, and printing the information of the items on the sheet according to the set layout.

According to another aspect of the present invention, a printing method for printing information of items relating to a print setting on a sheet, the printing method including: a first step for identifying an item that has been changed out of the items; and a second step for printing the item identified in the first step in an output style different from rest of the items to be printed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram illustrating a configuration of a printing apparatus according to an exemplary embodiment.

FIG. 2 is a block diagram illustrating a system configuration according to an exemplary embodiment.

FIG. 3 is a flowchart illustrating a processing procedure of status print according to an exemplary embodiment.

FIG. 4 is a flowchart illustrating a processing procedure for determining an output layout according to an exemplary embodiment.

FIGS. 5A, 5B, and 5C are diagrams illustrating example output layouts of the status print according to an exemplary embodiment.

FIGS. 6A and 6B are diagrams illustrating example output formats of conventional status print.

### DESCRIPTION OF THE EMBODIMENTS

Various exemplary embodiments, features, and aspects of the invention will be described in detail below with reference to the drawings.

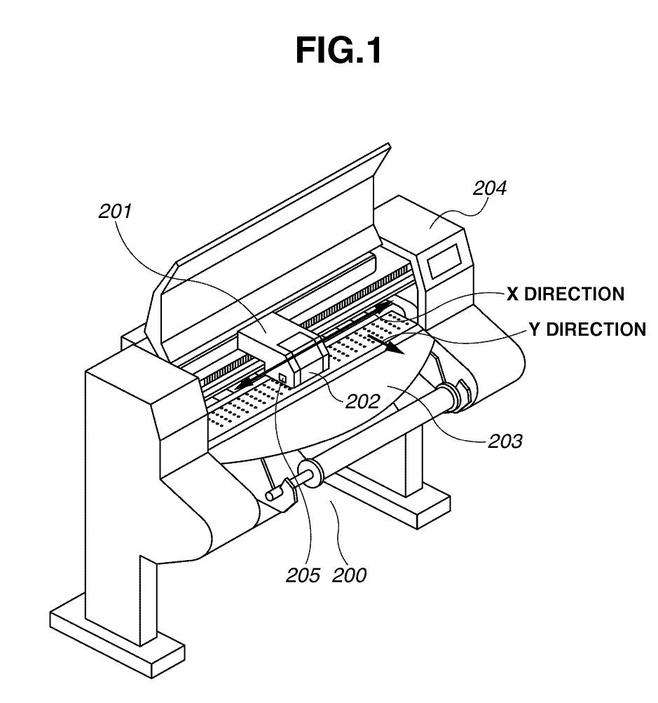

FIG. 1 is a perspective view illustrating a schematic configuration of a printing apparatus according an exemplary embodiment of the present invention. The printing apparatus of the present exemplary embodiment uses a roll sheet that is wound in a roll shape (long continuous sheet). An unused roll sheet 200 is set in a sheet feeding unit, and a sheet unwound from the roll sheet 200 is supplied to a recording unit to surround thereof from a lower portion of the apparatus.

In the recording unit, a carriage 201 makes a reciprocating movement in a main scanning direction. The carriage 201 includes a print head 202 and an ink tank (not shown) for supplying ink to the print head 202.

The print head 202 and the ink tank may integrally form an ink jet cartridge. Alternatively, the ink may be supplied from an ink tank disposed in a position separated from the carriage 201 to the print head 202 through a tube.

Various ink jet methods can be used to discharge ink from the print head 202. The ink jet methods include, but are not limited to, using a heating device, using a piezoelectric element, using an electrostatic element, and using a microelectromechanical systems (MEMS).

An image is printed on the sheet by repeatedly alternating between operation of discharging the ink while the print head 202 is moving in the main scanning direction (X direction) and operation of conveying the sheet stepwise in a sub-scanning direction (Y direction) in an amount of 1 band of a recording distance. Such a printing method is known as a serial printing method. In addition to the serial printing method, a line printing method may be used.

The printed sheet is discharged to a sheet discharge unit 203. A control unit 204 controls various operations of the entire printing apparatus. A sensor 205 is located in a position corresponding to a sheet in the carriage 201. The sensor 205 acquires information relating to a sheet width by detecting the presence or absence of the sheet by an optical method or any other method that would enable detecting the presence or absence of a sheet.

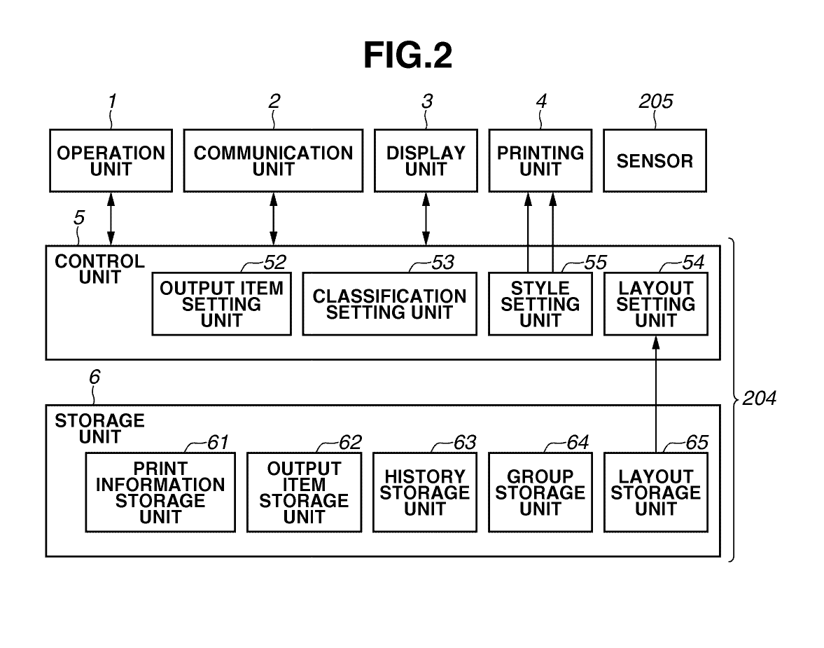

FIG. 2 is a system block diagram illustrating the printing apparatus. The control unit 204 includes a controller 5 including a processor and a storage unit 6 including a memory. The controller 5 is connected with an operation unit 1, a communication unit 2, a display unit 3, a printing unit 4, and the sensor 205.

The operation unit 1 includes an input device for inputting various kinds of information. The communication unit 2 includes various interfaces, such as a network interface and a universal serial bus (USB), for connecting with external devices such as a personal computer (PC) and an image input device. The printing apparatus receives image information and other information to be printed from the external device through the communication unit 2. Further, the printing apparatus can be controlled by execution of software installed in the external device through the communication unit 2.

The display unit 3 includes a display such as a liquid crystal display, and presents various kinds of information including a state of the printing apparatus to an operator. The printing unit 4 includes the carriage 201, the print head 202, and various motors for the print operation. The sensor 205 is located in the carriage 201 and is used to acquire the information relating to the sheet width.

The controller 5 includes a plurality of functional blocks for performing various processes of the printing apparatus. The plurality of functional blocks includes an output item setting unit 52, a classification setting unit 53, a layout setting unit 54, and a style setting unit 55. Although these functional blocks are conceptually separated for the sake of simple description, the functional blocks are configured as one processor or a plurality of processors with peripheral circuits thereof from a hardware standpoint.

The storage unit 6 includes a plurality of storage blocks such as a print information storage unit 61, an output item storage unit 62, a history storage unit 63, a group storage unit 64, and a layout storage unit 65, which are used for various processes by the controller 5.

The print information storage unit 61 collectively stores therein information relating to various settings of the printing apparatus. The output item storage unit 62 stores therein items to be output in status print. The history storage unit 63 stores therein output items of previous status print as a history.

The group storage unit 64 stores therein the items to be output as a plurality of groups by classifying the items by function. The layout storage unit 65 stores therein a layout of the status print to be output on a sheet. Each of these storage units is separated from one another as a memory space, but is not limited thereto. The information may be stored in a same memory space.

The output item setting unit 52 can read/write information out/in the print information storage unit 61, the output item storage unit 62, and the history storage unit 63. The output item setting unit 52 reads the information to be output in the status print out of the various information stored in the print information storage unit 61, and stores such information in the output item storage unit 62.

The classification setting unit 53 classifies the information stored in the output item storage unit 62 into a plurality of groups by category, and then stores the plurality of groups in the group storage unit 64. The layout setting unit 54 determines an output layout of the status print based on the information stored in the group storage unit 64, and then stores the output layout in the layout storage unit 65.

The style setting unit 55 compares the information stored in the output item storage unit 62 and the information stored in the history storage unit 63, and extracts an item that has been changed. Then, the style setting unit 55 sets an output style of characters in such a manner that the changed item is highlighted relative to items that have not been changed, and is output.

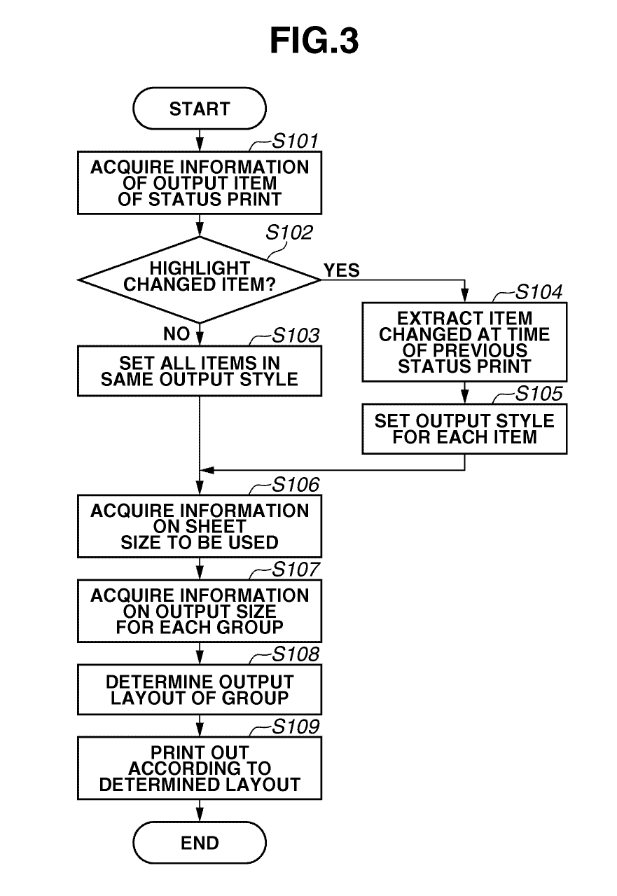

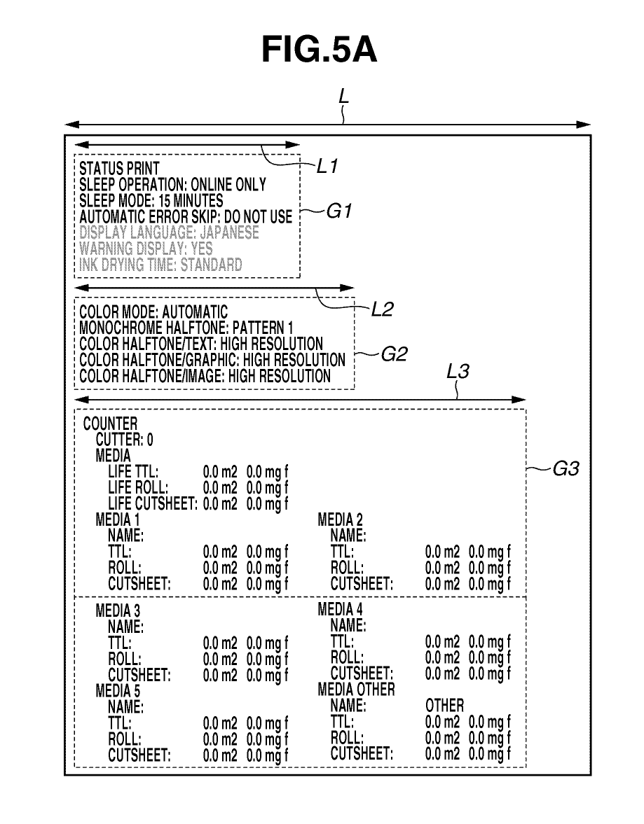

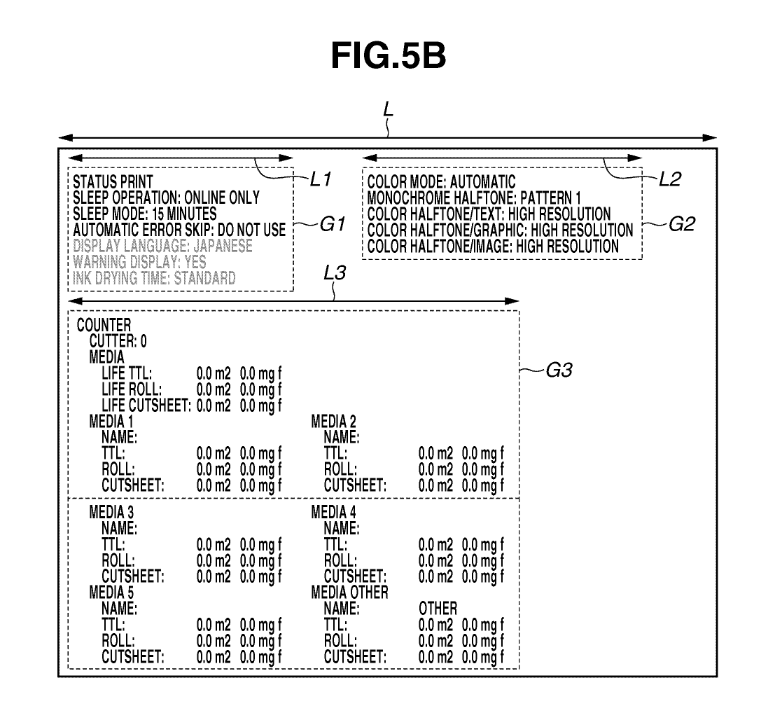

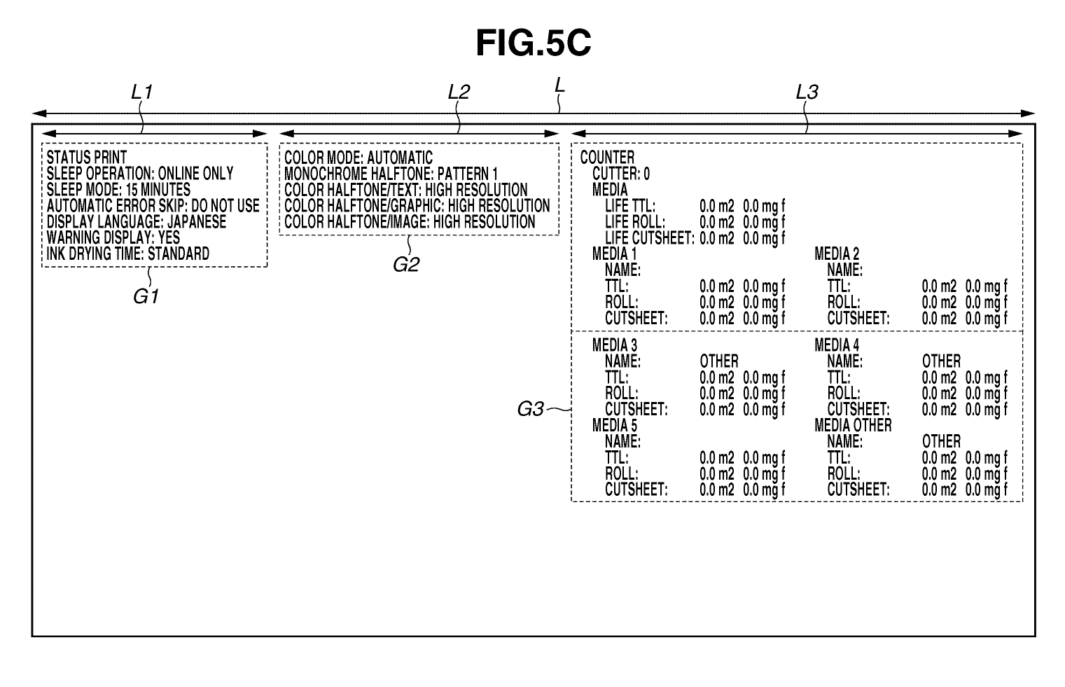

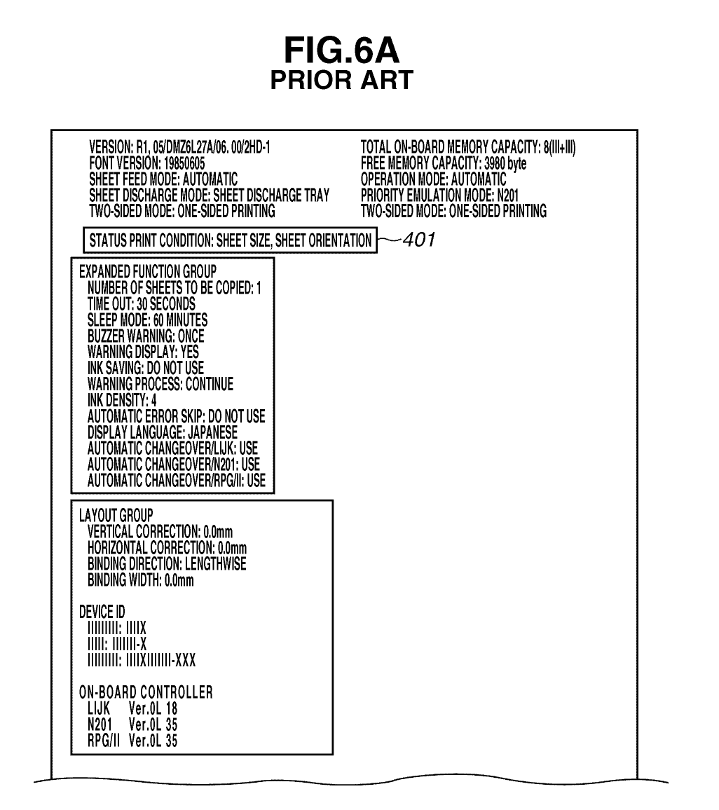

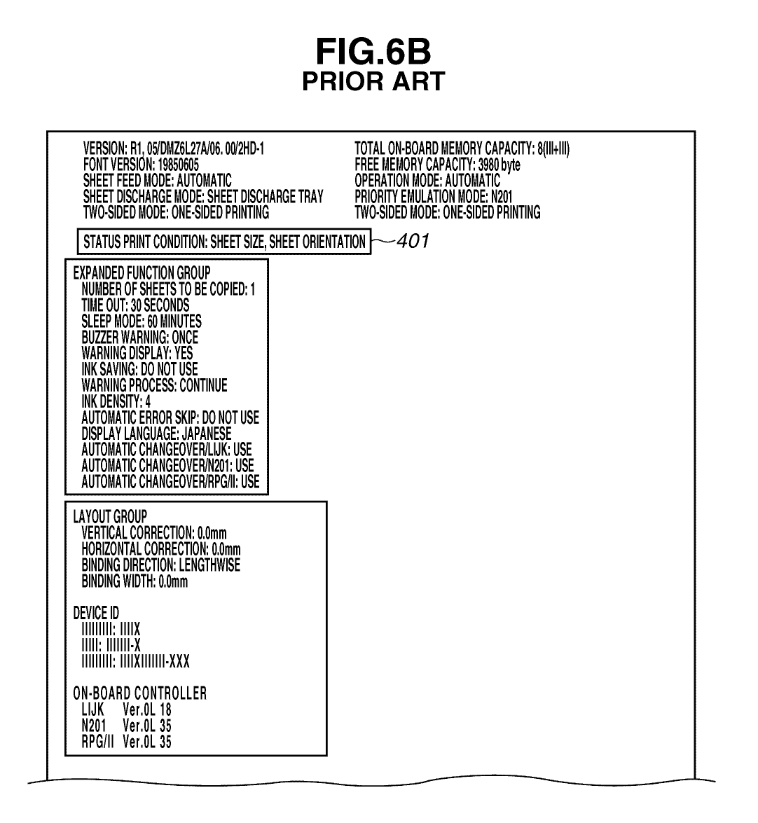

An example procedure for outputting the status print is described with reference to a flowchart of FIG. 3. The control unit 204 controls the sequence of the procedure. FIGS. 5A, 5B, and 5C illustrate status information in the status print on sheets. That is, FIGS. 5A, 5B, and 5C each illustrates an example layout in which items relating to the print setting are output in a plurality of lists.

In step S101, the output item setting unit 52 acquires information of output items of the status print. The output items are classified into a plurality of groups.

In step S102, the style setting unit 55 identifies whether a “highlight mode”, in which the item changed from the previous status print is highlighted, is ON or OFF. The default of the “highlight mode” at power-up is OFF. An operator can set ON or OFF of the “highlight mode” by inputting information through the operation unit 1 beforehand. The set information is stored in the print information storage unit 61.

The style setting unit 55 identifies whether the “highlight mode” is ON or OFF by referring to the print information storage unit 61. If the “highlight mode” is OFF (NO in step S102), the processing proceeds to step S103. If the “highlight mode” is ON (YES in step S102) the processing proceeds to step S104.

In step S103, the style setting unit 55 sets the output styles of all items to be output in the status print in such a manner that all the output items are output in the similar style in thickness, density, color, and size of the characters.

In step S104, the style setting unit 55 extracts the item changed from the previous status print.

The style setting unit 55 compares the items stored in the output item storage unit 62 and the items stored in the history storage unit 63, and determines whether the corresponding items match. If the corresponding items do not match, the style setting unit 55 determines that a change has been made in a time period between the previous status print and the present time. The style setting unit 55 marks the changed item by providing a flag so that the changed item can be identified.

In step S105, the style setting unit 55 sets an output style for each item to be output. The output style of the item changed from the previous status print and marked in step S104 is highlighted with higher visibility than that of the unchanged items. Thus, such an output style increases the visibility of an operator with respect to the changed item.

The output style can be highlighted in any one of the thickness, density, color, and size of the characters, or combination thereof. The output style can be changed for each item. For example, as illustrated in FIGS. 5A, 5B, and 5C, changed items are printed in dark color ink (black), whereas unchanged items are printed in lighter color ink (gray). Accordingly, the operator can readily recognize the changed item in the entire status print at a glance.

In the “highlight mode”, an additional mode may be provided to be selected from the operation unit 1. For example, an additional mode only allows changed items to be printed, and does not allow unchanged items to be printed entirely or partially. Since only the changed items are printed in such a mode, amounts of ink and sheets to be used for the status print can be reduced.

In step S106, the sensor 205 acquires information relating to a width of a sheet (hereinafter referred to as a sheet size) to be used. The sensor 205 detects the presence or absence of the sheet by moving the carriage 201, thereby acquiring the sheet size of the sheet supplied.

Alternatively, the information relating to the sheet size may be acquired by reading information that is set beforehand by an operator by inputting a size of a sheet to be used from the operation unit 1. In examples of FIGS. 5A, 5B, and 5C, a sheet width L in a main scanning direction, that is, the sheet size, increases in the order of FIGS. 5A, 5B, and 5C.

In step S107, the classification setting unit 53 chiefly acquires information relating to an output size for each group. The group storage unit 64 stores therein a width of the main scanning direction (sheet width direction) and a width of the sub-scanning direction as values containing predetermined blank space (margin). The group storage unit 64 stores therein such values for each of the plurality of groups, which are provided by classifying the items to be output by function.

The width is determined by the number of character strings to be output in vertical and horizontal directions. The classification setting unit 53 acquires the information by reading the information from the group storage unit 64.

In each example of FIGS. 5A, 5B and 5C, there are three groups G1, G2, and G3 that are print regions enclosed with dotted lines. The group G1 includes setting items such as a sleep operation, a sleep mode, an automatic error skip, a display language, and an ink drying time.

The group G2 includes setting items relating to color tones, such as a color mode, a monochrome halftone, a color halftone (text), a color halftone (graphic), and a color halftone (image).

The group G3 includes setting items relating to an amount of media usage and an amount of ink usage. The groups G1, G2, and G3 have sizes of L1, L2 and L3 (each including blank space) respectively in a sheet width direction thereof.

The three groups G1, G2 and G3 are assigned with priorities for arrangement. In this example, the groups G1, G2, and G3 are given priorities in the descending order. The group G1 having the highest priority is arranged on an upper left side of a sheet. The upper left side tends to be recognized most readily by an operator. When a layout is determined, groups are arranged in the descending order of priorities. Hereinafter, it is assumed that a group having an n-th priority has an output size of Gn in the sheet width direction.

In step S108, the layout setting unit 54 determines an output layout of the groups. The layout setting unit 54 determines the layout of the groups on a sheet based on the sheet size L and the output size Gn of each group.

FIG. 5A illustrates a case where a sheet size L of a sheet to be used is the smallest among the cases of FIGS. 5A through 5C. As illustrated in FIG. 5A, the groups G1, G2, and G3 are output in a vertical arrangement.

FIG. 5B illustrates a case where a sheet size L of a sheet to be used is medium. The groups G1 and G2 are output in a horizontal arrangement, whereas the group G3 is output in a vertical arrangement in a new row.

FIG. 5C illustrates a case where a sheet size L of a sheet to be used is the largest. The groups G1, G2, and G3 are output in a horizontal arrangement in a same row.

The sheet size L and the layout are associated, and then a relationship between the sheet size L and the layout is stored beforehand in the layout storage unit 65 in a data table format. The layout setting unit 54 determines the layout corresponding to the sheet size L by referring to the data table.

In step S109, the layout setting unit 54 outputs the status print in an appropriate layout for a sheet size according to the layout determined in step S108.

Therefore, the status print is output in a group-based layout that is determined according to a sheet size while character strings inside of each group remain the same arrangement. For example, when sheets having sizes of FIGS. 5B and 5C are used, the status prints are output without having large waste areas on right sides thereof, thereby reducing consumption amount of the sheets needed for the status print.

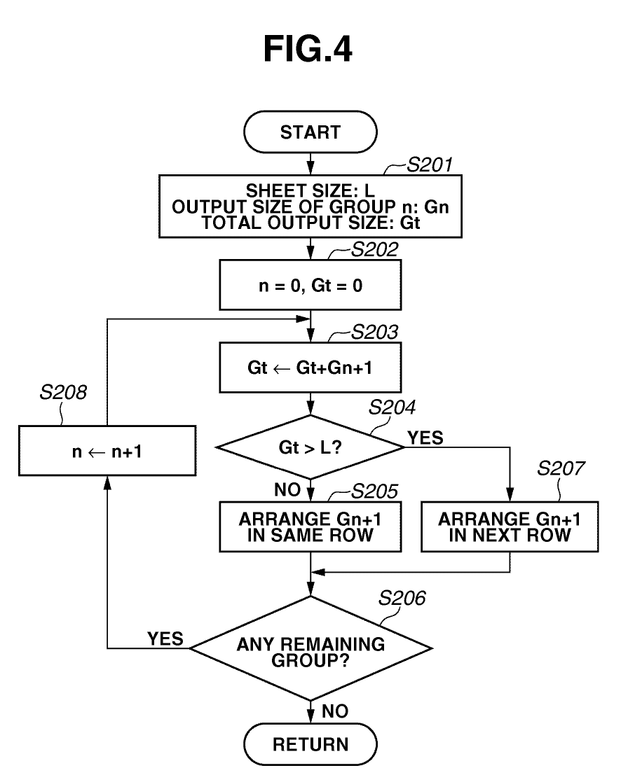

In step S108, the layout is determined using the sheet size and the layout which are associated and stored beforehand. However, the layout may be determined by performing calculation each time. Such a determination method is described with reference to a flowchart in FIG. 4.

A basic idea is that the layout is determined by using an algorithm that arranges as many groups as possible in a sheet width direction based on a sheet size L and a group width Gn. The layout setting unit 54 mainly performs this process.

In step S201, the layout setting unit 54 sets a sheet size L, an output size Gn of an n-th group, and a total output size Gt up to the n-th group as calculation parameters.

In step S202, the layout setting unit 54 sets n=0 and Gt=0 as initial values of the parameters. In step S203, the total output size (Gt+Gn+1) when an (n+1)-th group is arranged in the sheet width direction is calculated. A calculation result is updated as Gt. Accordingly, an example of FIG. 5B indicates Gt=L1+L2, whereas an example of FIG. 5C indicates Gt=L1+L2+L3.

In step S204, the layout setting unit 54 determines whether Gt>L. In other words, the layout setting unit 54 determines whether the total output size Gt acquired in step S203 exceeds the sheet width L, where Gt is the total output size when the groups are arranged up to the (n+1)-th group. If the total output size Gt does not exceed the sheet width L (NO in step S204), the processing proceeds to step S205. If the total output size Gt exceeds the sheet width L (YES in step S204), the processing proceeds to step S207.

In step 205, the layout setting unit 54 lays out the group Gn+1 to be in the same row as the groups up to the n-th group. Herein, the “row” indicates a row provided when a group is arranged as a unit, and does not indicate a row of character strings that form an item of status print. When the total output size Gt does not exceed the sheet size L (NO in step S204), the (n+1)-th group is arranged in the same row in which the groups up to the n-th group are arranged.

In step S207, the layout setting unit 54 lays out the group Gn+1 in a next row. In other words, when the total output size Gt exceeds the sheet size L (YES in step S204), there is not enough space for the group Gn+1 unless arranged in the next row.

In step S206, the layout setting unit 54 determines whether a group to be output in the status print remains unprocessed. If there is any remaining group (YES in step S206), the processing proceeds to step S208. If there is not any remaining group (NO in step S206), the processing routine ends. Then, the processing returns to step S109 in FIG. 3.

In step S208, the layout setting unit 54 increments a parameter n that indicates a group number (i.e., n←n+1). Subsequently, the processing returns to step S203 and repeats the processing from step S203.

Accordingly, after acquiring the information relating to the output size of each of the plurality of groups and the information relating to the layout priority, the layout setting unit 54 arranges the groups in the order of descending priorities in a sheet width direction and adds the output size of each of the groups. The layout setting unit 54 lays out the groups in the order of descending priorities in the sheet width direction so that the result of the addition does not exceeds a range of the sheet size.

According to the present exemplary embodiment, a layout of the status print is changed according to a size of a sheet to be used, so that a sheet consumption amount for the status print can be reduced. Moreover, items, which have been changed, are output in a different style from the rest of the items. Such an output style can allow an operator to recognize the changed items readily and promptly when the operator sees the output of the status print.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-007987 filed Jan. 18, 2011, which is hereby incorporated by reference herein in its entirety.

What is claimed is:

1. A method for printing information of items relating to a print setting on a sheet, the method comprising:
acquiring information relating to a width of a sheet to be used;
setting a layout for printing the information of the items according to the acquired width; and
printing the information of the items on the sheet according to the set layout.

2. The method according to claim 1, wherein the items to be printed are classified into a plurality of groups, and a layout of the plurality of groups is set according to the acquired width without changing a layout inside of each group.

3. The method according to claim 2, wherein information relating to an output size of each of the plurality of groups and information relating to layout priority are acquired, the output sizes of the groups are added in a descending order of priorities, the groups are laid out to be arranged in a sheet width direction in the descending order of priorities while a result of the addition does not exceed the sheet size, and when there is a remaining group, the remaining group is laid out to be printed in a new row.

4. The method according to claim 1, wherein the sheet is a continuous sheet wound in a roll shape.

5. The method according to claim 1, further comprising:
identifying an item that has been changed out of the items, and
wherein information of the identified item is printed in an output style different from rest of the items to be printed.

6. The method according to claim 5,
wherein the output style differs in at least one of thickness, size, color, and density of characters, and the changed item is printed in the output style having higher visibility of an operator than an output style of the rest of the items.

7. The method according to claim 5, wherein the identified item is printed while the rest of the items are not printed partially or entirely by selecting a mode.

8. A printing apparatus, comprising:
a recording unit configured to record an image;
an acquiring unit configured to acquire information relating to a width of a sheet to be used; and
a setting unit configured to set a layout for printing information of items relating to a print setting based on the width acquired by the acquiring unit;
wherein the recording unit prints the information of the items on the sheet according to the layout set by the setting unit.

9. A method for printing information of items relating to a print setting on a sheet, the method comprising:
identifying an item that has been changed out of the items; and
printing the identified item in an output style different from the rest of the items to be printed.

10. The method according to claim 9,
wherein the output style differs in at least one of thickness, size, color, and density of characters, and the changed item is printed in the output style having higher visibility of an operator than an output style of the rest of the items.

11. The method according to claim 9, wherein the identified item is printed while the rest of the items are not printed partially or entirely by selecting a mode.
